(19) United States
(12) Patent Application Publication
(10) Pub. No.: US 2008/0009169 A1
(43) Pub. Date: Jan. 10, 2008

(54) FIXING MECHANISM FOR ELECTRONIC DEVICE

(76) Inventor: Linger LIN, Taipei (TW)

Correspondence Address: FULBRIGHT AND JAWORSKI LLP, 555 S. FLOWER STREET, 41ST FLOOR, LOS ANGELES, CA, 90071, US

(21) Appl. No.: 11/456,476

(22) Filed: Jul. 10, 2006

(51) Int. Cl. H01R 4/50

(52) U.S. Cl. 439/342

(57) ABSTRACT

A fixing mechanism having a fixing component, a positioning component, and a guiding component is disclosed. The fixing component has a mating portion and a groove portion hooked with the guiding component. After the guiding component passes through the groove portion of the fixing component, the fixing component can glide on a housing of an electronic device, such that the positioning component can be fixed to the mating portion, the fixing component can be fixed to the housing, so as to block and fix the cover of an electronic device to the housing, thereby preventing the cover from detaching from the housing due to a greater force.

### BACKGROUND OF THE INVENTION

1. Field of the Invention

The present invention relates to fixing mechanisms, and more particularly, to a fixing mechanism that can prevent the movement and detachment of a lid from an electronic device.

2. Description of Related Art

In general, a lid of an electronic device is fastened to a housing of the electronic device by screws or rivets, to protect a circuit board and varieties of electronic components installed in the electronic device. However, such a fastening mechanism using screws to secure the lid has disadvantages in operation as it necessitates the use of tools, the labor and the time spent in assembly and disassembly for replacement or maintenance purposes, decreasing the working efficiency as a result.

To resolve the problems mentioned above, a known fixing structure as depicted in FIG. 5 is disclosed. Two guiding track portions 32 are respectively disposed on two sides of a housing of an electronic device. A plurality of positioning grooves 31 are disposed at one end of the housing. Two guiding grooves 33 corresponding to the guiding track portions 32 are disposed at two sides of an upper lid of the electronic device. A plurality of positioning hooks 34 corresponding to the positioning grooves 31 are disposed at one end of the upper lid. Therefore, the upper lid is allowed to be fastened to the housing by the guidance of the guiding track portions 32 along the guiding grooves 33 and the fastening of the positioning hooks 34 to the positioning grooves 31.

In other words, the fixing structure discussed above fastens the cover/upper lid to the housing by means of coupling the positioning hook 34 with the positioning groove 31. However, the upper lid tends to move and detach from an electronic device when being impacted by greater external forces, resulting in potential damages to the electronic device.

Therefore, it is desirable to develop a novel mechanism that can improve on the drawbacks of prior art techniques by preventing the detachment of the upper lid from an electronic device.

### SUMMARY OF THE INVENTION

The present invention aims to eliminate the aforementioned drawbacks, and, as such, a primary objective of the present invention is to provide a fixing mechanism that prevents the detachment of the upper lid due to a greater impact inflicted thereupon.

Another objective of the present invention is to provide a fixing mechanism that is easy to install without the use of a tool.

Another objective of the present invention is to provide a fixing mechanism that is easy to produce at a lower cost.

In order to achieve the above and other objectives, the present invention provides a fixing mechanism for fixing electronic devices, the fixing mechanism at least comprising: a fixing component, a positioning component and a guiding component, adapted to secure a lid body of an electronic device and prevent the upper lid thereof from moving and detaching from the housing of an electronic device.

The fixing component is comprised of a mating portion and a groove portion which respectively connect with the positioning component and the guiding component for fixing onto the housing of an electronic device to block the lid body thereof, wherein the mating portion is constituted by an elastic piece and a hook to thereby couple the positioning component with the hook thereof to fasten the fixing component onto the housing; and the groove can be a spacing aperture and the mating portion is formed with a coupling bump that can be used to adjust the heights of the fixing component according to the actual requirement, and two corresponding bumps are formed between the mating portion and the groove portion to space apart the mating portion and the groove portion.

The positioning component is disposed on the housing for coupling with the mating portion to fasten the fixing component onto the housing.

The guiding component is disposed on the housing and level with the positioning component, allowing the fixing component to pass through the groove portion via the guiding component and to slide axially with respect to the housing.

In summary, the fixing mechanism of the invention features using a guiding component to pass through a groove portion of a fixing component, such that the fixing component can slide with respect to the housing of an electronic device, allowing the positioning component to couple with the mating portion of the fixing component to fasten the fixing component onto the housing, thereby blocking the lid body of the electronic device to secure the lid body thereon and preventing the detachment of the lid body from the electronic device due to a greater impact inflicted thereupon.

Accordingly, the present invention offers advantages over the prior art techniques in that it is a simple structure that is easy to install without using any tool to securely fasten the lid body to the electronic device, and the positioning component and the guiding component thereof can be integrally formed with the housing by stamping/punching to save the production cost.

### BRIEF DESCRIPTION OF DRAWINGS

The fixing mechanism of the present invention can be fully understood by reading the following detailed description of the preferred embodiments, with reference made to the accompanying drawings, wherein:

FIG. 1 is a schematic view illustrating the structure of a first embodiment of the fixing mechanism in accordance with the invention;

FIG. 2 is a schematic view illustrating the assembly of the first embodiment of the fixing mechanism in accordance with the invention;

FIG. 3 is a schematic view illustrating the structure of another embodiment of the fixing mechanism in accordance with the invention;

FIG. 4 is a schematic view illustrating the assembly of a second embodiment of the fixing mechanism in accordance with the invention; and

FIG. 5 (PRIOR ART) is a schematic view illustrating the structure of a known fixing mechanism.

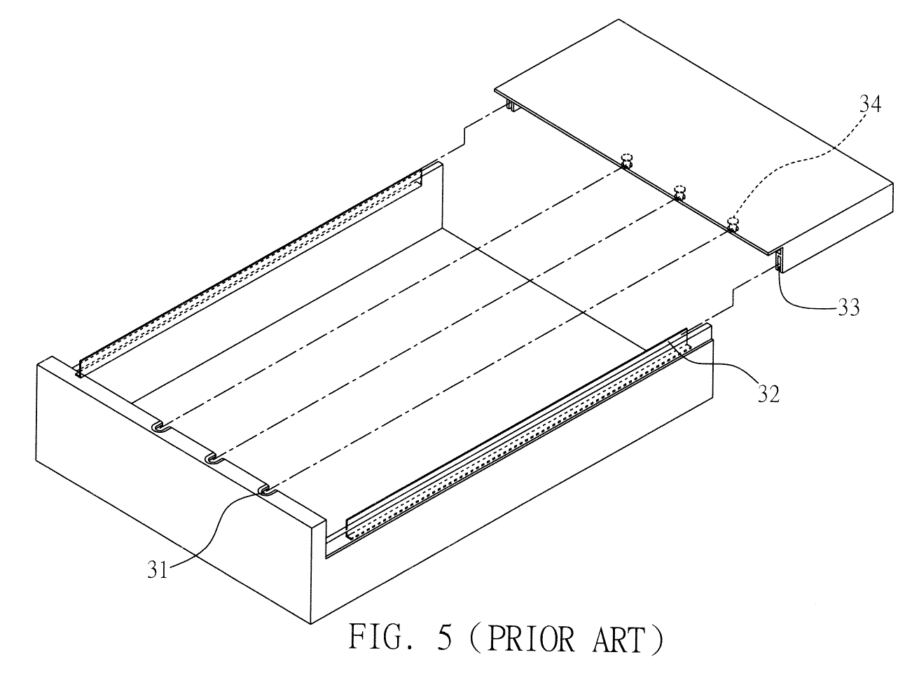

### DETAILED DESCRIPTION OF PREFERRED EMBODIMENT

The present invention is described in the following so that one skilled in the pertinent art can easily understand other advantages and effects of the present invention. The present invention may also be implemented and applied according to other embodiments, and the details may be modified based on different views and applications without departing from the spirit of the invention.

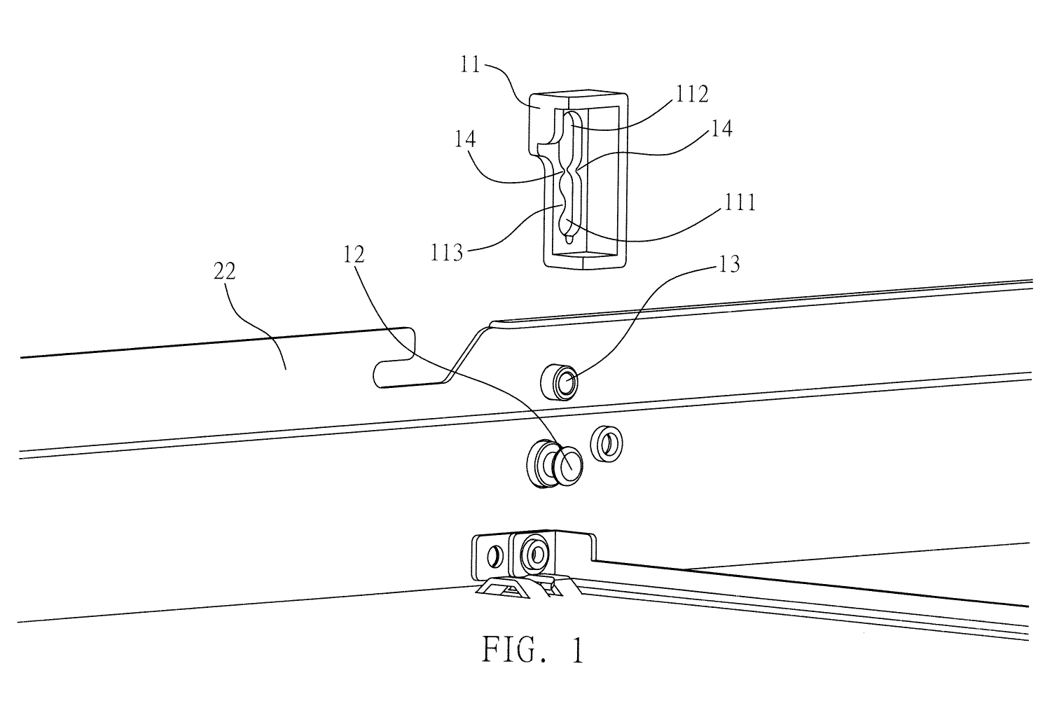

FIG. 1 is a schematic diagram of a fixing mechanism of a first embodiment according to the invention. The fixing mechanism comprises a fixing component 11, a positioning component 12, and a guiding component 13. The fixing mechanism is used for fastening a lid to an electronic device to a housing 22 of the electronic device. The guiding component 13, the positioning component 12 and the housing 22 can be integrally formed by a stamping process to save the production cost. However, note that the guiding component 13 and the positioning component 12 are not limited to the integral formation by stamping but can vary according to design choices and actual applications.

The fixing component 11 is made of plastic. The fixing component 11 comprises a mating portion 111 and a groove portion 112 for engaging with the positioning component 12 and the guiding component 13 respectively, so as to fix the fixing component 11 to the housing 22 of the electronic device to block the lid of the electronic device. The fixing component 11 further comprises two bumps 14 formed between the mating portion 111 and the groove portion 112 for separating the mating portion 111 from the groove portion 112. According to the first embodiment, the groove portion 112 is a spacing aperture. The fixing component 11 further comprises a coupling bump 113 formed beside the mating portion 111 for adjusting a height of the fixing component 11 according to the actual requirements.

Note that the fixing component 11 of the present invention can comprise more than one mating portion 111.

The positioning component 12 is disposed on the housing 22 of the electronic device. According to the first embodiment, the positioning component 12 is a screw, which can be coupled with the mating portion 111 to fasten the fixing component 11 to the housing 22.

The guiding component 13 is also disposed on the housing 22 of the electronic device and is parallel to the positioning component 12. According to the first embodiment, the guiding component 13 is a cylinder and is used for guiding the fixing component 11 to pass through the groove portion 112 and slide axially with respect to the housing 22.

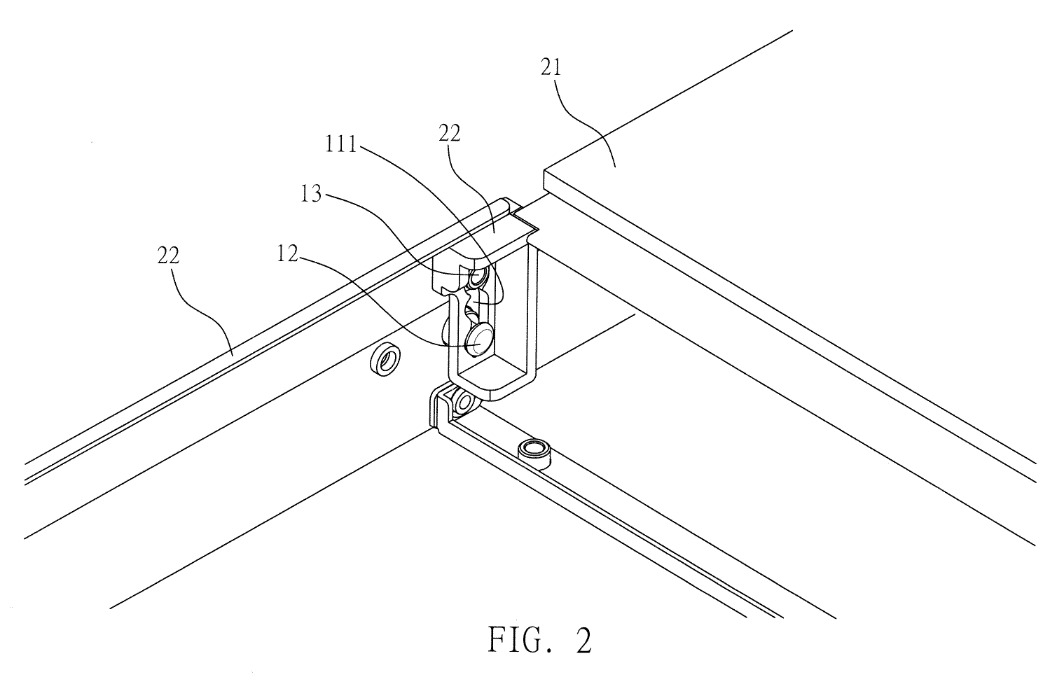

FIG. 2 illustrates an assembly state of the fixing mechanism of the first embodiment according to the present invention. The positioning component 12 and the guiding component 13 are disposed on the housing 22 of the electronic device. The guiding component 13 guides the fixing component 11 having the mating portion 111 and the groove portion 112 to pass through the groove portion 112. Therefore, the fixing component 11 can slide with respect to the housing 22, and the positioning component 12 can be fixed to the mating portion 111 and the fixing component 11 can be fixed to the housing 22, thereby blocking a lid 21 of the electronic device to secure the lid 21 thereon and preventing detachment of the lid 21 from the electronic device due to greater forces in usage.

The mating portion 111 is formed with a coupling bump 113 which can be used to adjust the heights of the fixing component 11 according to the actual requirements, and two correspondent bumps are formed between the mating portion 111 and the groove portion 112 to space apart the mating portion and the groove portion.

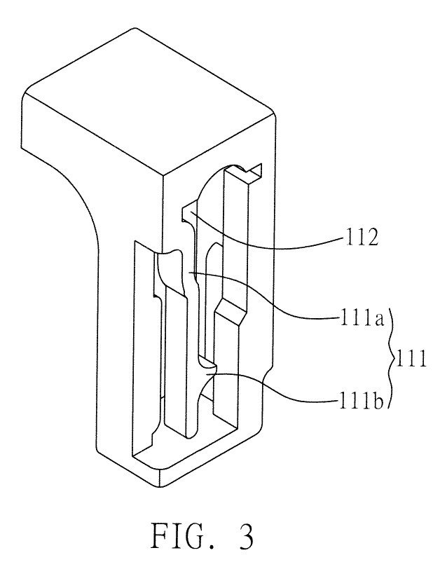

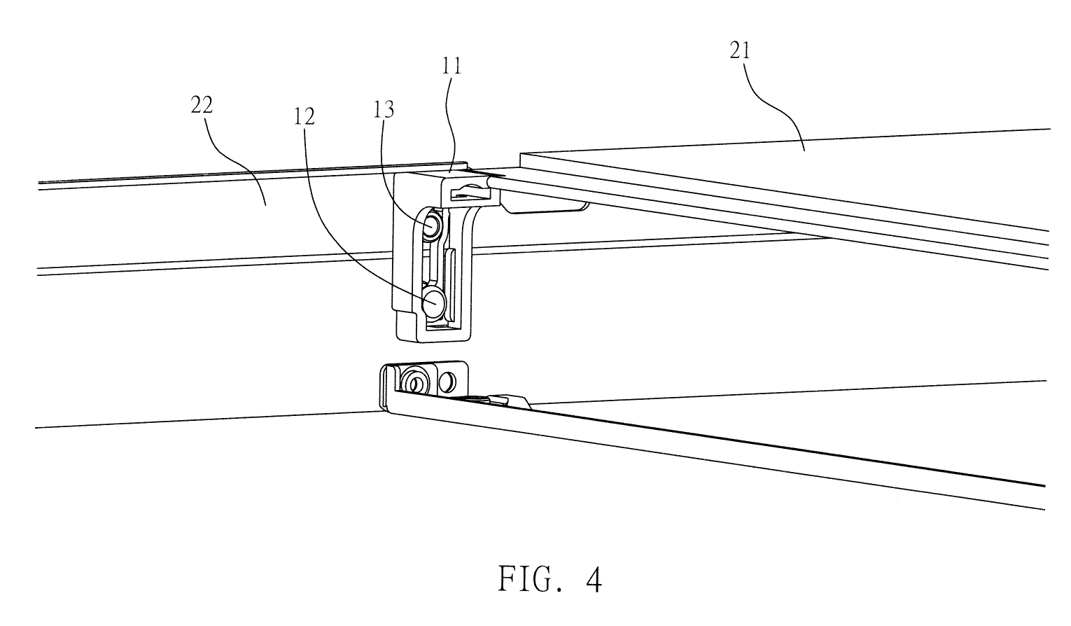

FIG. 3 illustrates a different structure of another embodiment of the fixing mechanism, whereas FIG. 4 illustrates the assembly of a second embodiment of the fixing mechanism in accordance with the invention. The second embodiment is structurally similar to the previous first embodiment, which mainly differs in that the mating portion 111 in this embodiment is constituted by an elastic piece 111a and a hook 111b, such that when the fixing component 11 passes through the groove portion 112 via the guiding component 13 to slide with respect to the housing, the positioning component 12 is actuated to push the spring 111a to slide the positioning component 12 to couple the hook 111b, thereby fastening the fixing component 11 onto the housing 22 to prevent the lid body 21 of the housing 22 from moving and detaching from the housing 22.

In summary, the fixing mechanism of the invention is characterized in that a guiding component is employed to pass through a groove portion of a fixing component, allowing the fixing component to slide with respect to the housing of an electronic device, thereby coupling the positioning component with the mating portion of the fixing component to securely fasten the fixing component onto the housing, so as to block the lid body of the electronic device and to secure the lid body thereon and prevent the detachment of the lid body from the electronic device due to a greater impact inflicted thereupon.

Also, the fixing mechanism of the present invention is a simple structure that is easy to install without using any tool to securely fasten the lid body to the electronic device, and the positioning component and the guiding component thereof can be integrally formed with the housing by stamping/punching to reduce the production cost.

The aforementioned are only exemplary preferred embodiments of the present invention. The scope of the claims as stated below should be accorded the broadest interpretation so as to encompass various modifications and similar arrangements made to the herein described invention that fall within the spirit of the basic principles and technology of the present invention.

What is claimed is:

1. A fixing mechanism adapted to fix a lid of an electronic device to a housing of the electronic device, the fixing mechanism comprising:
a fixing component for blocking the lid, the fixing component having a mating portion and a groove portion;
a positioning component disposed on the housing for coupling with the mating portion to fasten the fixing component to the housing; and
a guiding component disposed on the housing for guiding the fixing component to pass through the groove portion and allowing the fixing component to slide axially with respect to the housing.

2. The fixing mechanism according to claim 1, wherein the mating portion comprises an elastic piece and a hook.

3. The fixing mechanism according to claim 1, wherein the mating portion is a spacing aperture.

4. The fixing mechanism according to claim 1, wherein the mating portion is made of plastic.

5. The fixing mechanism according to claim 1 further comprises two correspondent bumps formed between the mating portion and the groove portion for separating the mating portion from the groove portion.

6. The fixing mechanism according to claim 1, wherein the positioning component is a screw.

7. The fixing mechanism according to claim 1, wherein the guiding component is a cylinder.

8. The fixing mechanism according to claim 1, wherein the guiding component and the positioning component are integrally formed with the housing by a stamping process.
